(19) United States
(12) Patent Application Publication
(10) Pub. No.: US 2010/0085448 A1
(43) Pub. Date: Apr. 8, 2010

(54) SOLID STATE IMAGING DEVICE

(75) Inventor: Naoto Fukuoka, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/572,762

(22) Filed: Oct. 2, 2009

(30) Foreign Application Priority Data
Oct. 7, 2008 (JP) 2008-260898

(51) Int. Cl. H04N 5/335; H04N 5/217; H04N 3/14

(52) U.S. Cl. 348/241; 348/302; 348/308; 348/E05.091; 348/E05.079

(57) ABSTRACT

A solid state imaging device includes at least a plurality of first pixels, a plurality of second pixels, a signal line, and a fixing portion. The plurality of first pixels includes a photoelectric conversion portion which converts incident light into a signal charge and accumulates the converted signal charge. The plurality of second pixels includes the photoelectric conversion portion and is shaded so that the incident light is not incident on the photoelectric conversion portion. The signal line is electrically connected to the first or second pixel and is used to transmit a pixel signal, which corresponds to the signal charge and is output from the first or second pixel. The fixing portion fixes the level of the signal line so that the level of the signal line connected to the second pixel does not become equal to or more than a predetermined level or does not become equal to or less than the predetermined level.

### BACKGROUND OF THE INVENTION

1. Field of the Invention

The present invention relates to a solid state imaging device used in a video camera, a digital still camera, and the like.

Priority is claimed on Japanese Patent Application No. 2008-260898, filed Oct. 7, 2008, the content of which is incorporated herein by reference.

2. Description of Related Art

In recent years, a CMOS (Complementary Metal Oxide Semiconductor) type image sensor (imaging device) has been drawing attention as a solid state imaging device and has also been put to practical use. The MOS type imaging device may be driven by a single power source, compared with a CCD (Charge Coupled Device) type image sensor (imaging device). In addition, the same manufacturing process as for other LSIs is used for the MOS type image sensor, while a dedicated process is needed for the CCD type image sensor. Accordingly, in the case of the MOS type image sensor, SOC (System On Chip) is easily realized, and it becomes possible to realize multiple functions. In addition, since the MOS type image sensor has an amplifier for every pixel, a signal charge is amplified within a pixel. Accordingly, it is difficult to be influenced by a noise through the signal transmission path. In addition, the signal charge of each pixel can selectively be extracted. Therefore, in principle, the storage time of a signal or the read order of a signal can be freely controlled for every pixel.

Usually, an imaging region of an MOS type image sensor is formed by two regions of an optical black region (OB region), which is formed by a plurality of pixels shaded so that the light is not incident, and an effective pixel region which is formed by a plurality of pixels that is not shaded. The OB region is a region from which a black (state without light) level is always output by shading.

FIGS. 10A and 10B show an image when it is dark, which was photographed under the conditions in which the entire surface of the imaging region of an MOS type image sensor was shaded. As an example, it is assumed that an OB region 1010 is disposed on the left and upper sides of an effective region 1000 as shown in FIGS. 10A and 10B. In an MOS type image sensor, a line noise 1020 or non-uniformity (shading) of the black level appears due to a noise caused by the temperature or a circuit, as shown in FIG. 10A. The pixel output of the OB region 1010 is used when determining the black level of a sensor output or when correcting a line noise or shading of the black level when it is dark. FIG. 10B shows an image obtained by correcting the image of the effective region 1000 using the output of the OB region 1010. As shown in FIG. 10B, the line noise and shading of the effective region 1000 are corrected.

FIG. 11 shows the configuration of a typical MOS type image sensor. AN MOS type image sensor 2-0 shown in FIG. 11 is assumed to have a pixel structure of six rows by six columns for the sake of simplicity. The MOS type image sensor 2-0 includes a vertical scanning circuit 2-1, a horizontal scanning circuit 2-2, a control signal generating circuit 2-3, a ground line 2-4, a current source 2-5, a pixel 2-6, a vertical signal line 2-7, a CDS circuit 2-8, a column selection switch 2-9, a horizontal signal line 2-10, and an output amplifier 2-11.

The pixel 2-6 includes a photodiode as a photoelectric conversion portion which converts the incident light into a signal charge and accumulates the converted signal charge. The vertical scanning circuit 2-1 controls the pixel 2-6. The vertical signal line 2-7 outputs a signal (pixel signal) of the pixel 2-6. The constant current source 2-5 drives the vertical signal line 2-7. The ground line 2-4 is connected to the constant current source 2-5. The CDS circuit 2-8 removes a noise component of a pixel signal.

The column selection switch 2-9 selects the vertical signal line 2-7. The horizontal signal line 2-10 outputs a signal of the vertical signal line 2-7. The output amplifier 2-11 amplifies a signal of the horizontal signal line 2-10. In addition, an OB region 2-12 shaded so that the light is not incident on the photoelectric conversion portion is formed by first and second row pixels and first and second column pixels out of the pixels 2-6, and an effective region 2-13 which is not shaded is formed by the other pixels.

The vertical scanning circuit 2-1 transmits to the pixel 2-6 a pixel reset pulse φRS, a charge transfer pulse φTX, and a pixel selection pulse φSE for controlling the pixel 2-6. The horizontal scanning circuit 2-2 transmits to the column selection switch 2-9 a column selection pulse φH for controlling the column selection switch 2-9. The control signal generating circuit 2-3 transmits to each of the vertical scanning circuit 2-1 and the horizontal scanning circuit 2-2 a command regarding its control. In addition, the control signal generating circuit 2-3 transmits to the CDS circuit 2-8 a clamp pulse φCL and a sample hold pulse φSH for controlling the CDS circuit 2-8.

FIG. 12 shows the circuit configuration when a circuit corresponding to the pixels on a certain column in FIG. 11 is noted. The same components as in FIG. 11 are denoted by the same reference numerals as in FIG. 11. The constant current source 2-5 has a constant current source transistor M1 with a gate connected to a constant current source gate line 3-1. The pixel 2-6 converts the irradiated light into an electric signal and outputs it to the vertical signal line 2-7. The pixel 2-6 has a pixel reset transistor M2, a charge transfer transistor M3, an amplification transistor M4, a pixel selection transistor M5, a photodiode PD, and a floating diffusion FD. A gate of each transistor in the pixel 2-6 is connected to a pixel reset pulse line 3-3, a charge transfer pulse line 3-4, the floating diffusion FD, and a pixel selection pulse line 3-5. In addition, a common pixel power line 3-2 connected to all of the pixels is connected to drains of the pixel reset transistor M2 and amplification transistor M4.

The CDS circuit 2-8 serves to remove a different noise component for every pixel. The CDS circuit 2-8 has a clamp capacitor C1, a clamp transistor M6, a sample hold capacitor C2, and a sample hold transistor M7. A gate of each transistor in the CDS circuit 2-8 is connected to a clamp pulse line 3-7 and a sample hold pulse line 3-8. The column selection switch 2-9 has a column selection transistor M8 with a gate connected to a column selection pulse line 3-9.

FIGS. 13A and 13B show an image when the effective region has been corrected using the data of the OB region where there is a white defect. Here, the white defect means a phenomenon which occurs when a dark current is larger than that in other pixels and in which the pixel output becomes a larger level than surrounding pixels. FIG. 13A shows an image when there is a white defect 1330 on the upper right side of an OB region 1310. Since the image in FIG. 13A is an image before the correction, a line noise 1320 and shading remain in an effective region 1300.

FIG. 13B shows an image after performing the correction using the output of the OB region 1310. In the effective region 1300, the line noise and shading are reduced by the correction.

However, in the pixel string corresponding to the pixel string of the OB region 1310 where there is the white defect 1330, a black line noise 1340 appears to the contrary by correction. This is because the data for correction includes the white defect and accordingly, the level of the white defect is more subtracted when performing subtraction processing, for example. In addition to the defect, it is also considered that the light leaks to the OB region and the output increases. Thus, when the OB region which is to output the black level originally outputs an abnormal value due to the defect or leakage of light, an image of the effective region is made to deteriorate to the contrary by performing OB clamp or other correction.

In order to solve the abnormal value of the OB region, for example, Japanese Unexamined Patent Application, First Publication, No. 2002-77738 proposes to provide a storage means for storing the information indicating whether or not a signal output from the OB region is appropriate and to determine the clamp level using the signal output of the storage means. In addition, Japanese Unexamined Patent Application, First Publication, No. 2006-261932 proposes to provide a detection means for detecting the signal level of the OB level and to make the OB level constant by short-circuiting a circuit, which holds a reset level and a signal level, with a CDS circuit according to the output of the detection means.

### SUMMARY OF THE INVENTION

According to an aspect of the invention, a solid state imaging device includes at least: a plurality of first pixels (corresponding to the pixel 2-6 of the effective region 2-13 in FIG. 1 or the like) including a photoelectric conversion portion (corresponding to the photodiode FD in FIG. 2 or the like) which converts incident light into a signal charge and accumulates the converted signal charge; a plurality of second pixels (corresponding to the pixel 2-6 of the OB region 2-12 in FIG. 1 or the like) which includes the photoelectric conversion portion and is shaded so that the incident light is not incident on the photoelectric conversion portion; a signal line (corresponding to the vertical signal line 2-7 in FIG. 1 or the like) which is electrically connected to the first or second pixel and is used to transmit a pixel signal, which corresponds to the signal charge and is output from the first or second pixel; and a fixing portion (corresponding to the clipping circuit 5-1 in FIGS. 1 and 9, the non-read pixel of the OB region 2-12 in FIG. 4, and the clipping voltage generating pixel 11-6 in FIG. 7) which fixes a level of the signal line so that the level of the signal line connected to the second pixel does not become equal to or more than a predetermined level or does not become equal to or less than the predetermined level.

Moreover, it is preferable that the solid state imaging device according to the aspect of the invention further includes a noise removing portion (corresponding to the CDS circuit 2-8 in FIG. 1 or the like) which removes a noise from the pixel signal output to the signal line and the fixing portion be disposed between a point, at which the first or second pixel is connected to the signal line, and the noise removing portion.

Moreover, in the solid state imaging device according to the aspect of the invention, it is more preferable that the fixing portion be provided with the first or second pixel.

Moreover, in the solid state imaging device according to the aspect of the invention, it is preferable that the first or second pixel which forms the fixing portion comprises: a reset portion which resets the signal charge accumulated in the first or second pixel; and a selection portion which selects an output of the first or second pixel.

Moreover, it is more preferable that the solid state imaging device according to the aspect of the invention further includes a setting portion (corresponding to the vertical scanning circuit 8-1 in FIG. 4) which sets the pixel, to which a signal is to be output, out of the first and second pixels, wherein the fixing portion is provided with the second pixels other than the pixel to which a signal is to be output.

Moreover, it is preferable that the solid state imaging device according to the aspect of the invention further includes a control portion (corresponding to the control signal generating circuit 13-3 in FIG. 9) which controls the level of a voltage as a reference used to determine the predetermined level according to temperature.

Moreover, it is more preferable that the solid state imaging device according to the aspect of the invention further includes a control portion (corresponding to the control signal generating circuit 13-3 in FIG. 9) which controls the level of a voltage as a reference used to determine the predetermined level according to the time for which the signal charge is accumulated.

In the above, a description of the portions put in parentheses is to match the embodiments of the invention with the components of the invention, which will be described later, for the sake of convenience and the contents of the invention are not limited by the description.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating the configuration of a solid state imaging device according to a first embodiment of the invention;

FIG. 2 is a circuit diagram illustrating the configuration of a circuit corresponding to a column of pixels provided in the solid state imaging device according to the first embodiment of the invention;

FIG. 3 is a timing chart illustrating the operation of the solid state imaging device according to the first embodiment of the invention;

FIG. 4 is a block diagram illustrating the configuration of a solid state imaging device according to a second embodiment of the invention;

FIG. 5 is a circuit diagram illustrating the configuration of a circuit corresponding to a column of pixels provided in the solid state imaging device according to the second embodiment of the invention;

FIG. 6 is a timing chart illustrating the operation of the solid state imaging device according to the second embodiment of the invention;

FIG. 7 is a block diagram illustrating the configuration of a solid state imaging device according to a third embodiment of the invention;

FIG. 8 is a timing chart illustrating the operation of the solid state imaging device according to the third embodiment of the invention;

FIG. 9 is a block diagram illustrating the configuration of a solid state imaging device according to a fourth embodiment of the invention;

FIGS. 10A and 10B are reference views illustrating how an image is corrected using the output of a pixel of the OB region;

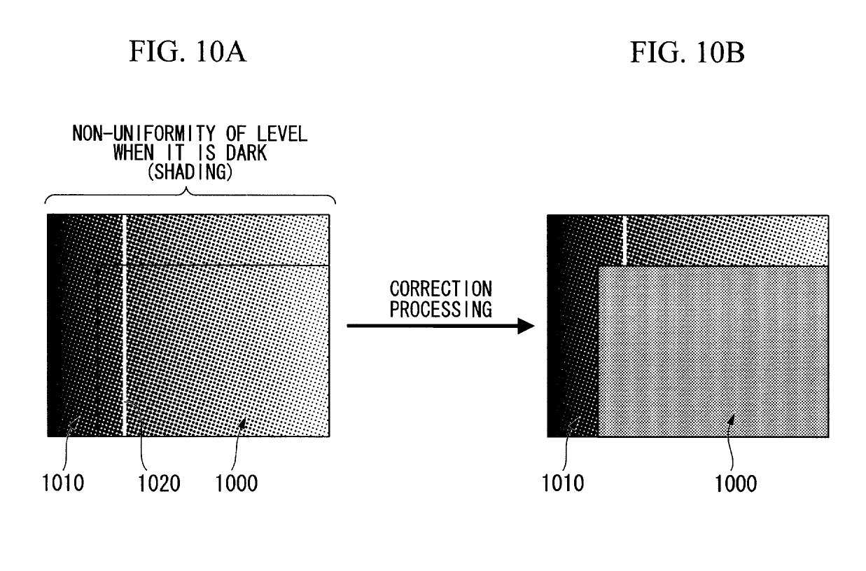

FIG. 11 is a block diagram illustrating the configuration of a known solid state imaging device;

FIG. 12 is a circuit diagram illustrating the configuration of a circuit corresponding to a column of pixels provided in the known solid state imaging device; and

FIGS. 13A and 13B are reference views illustrating how an image is corrected using the output of a pixel of the OB region.

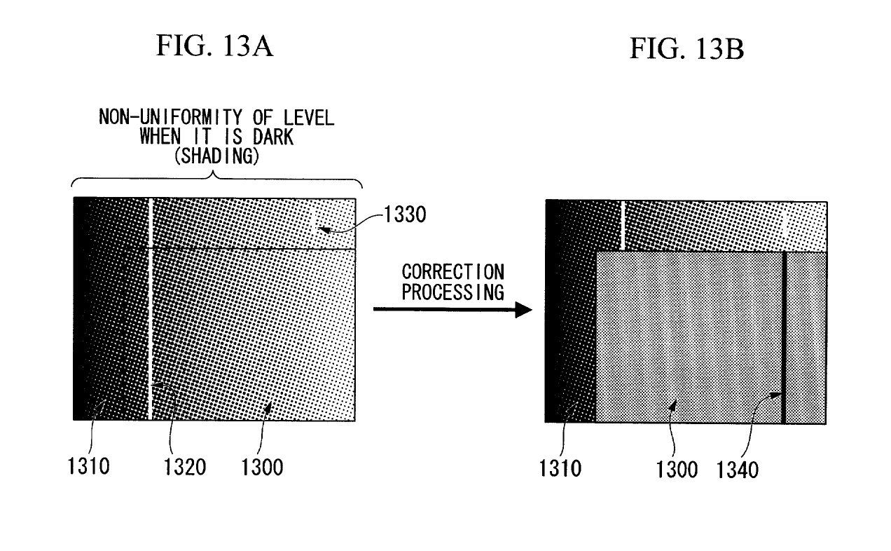

### DETAILED DESCRIPTION OF THE INVENTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereinafter, embodiments of the invention will be described with reference to the accompanying drawings.

### First Embodiment

To begin with, a first embodiment of the invention will be described. The first embodiment is related to a solid state imaging device to which a method of clipping a vertical signal line with a clip circuit in a pixel is applied.

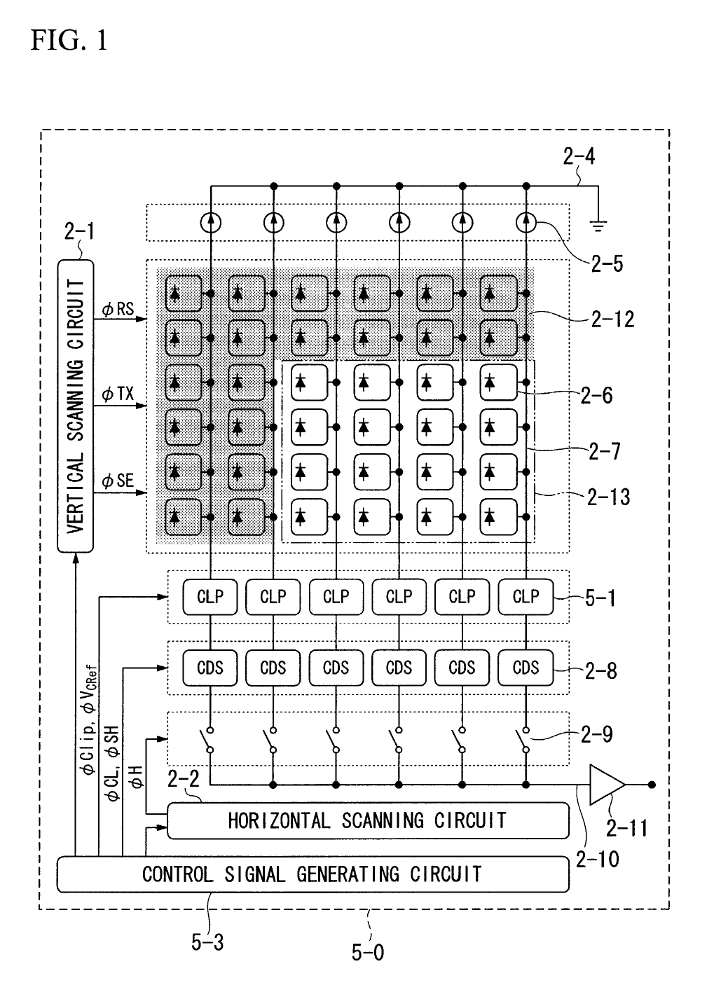

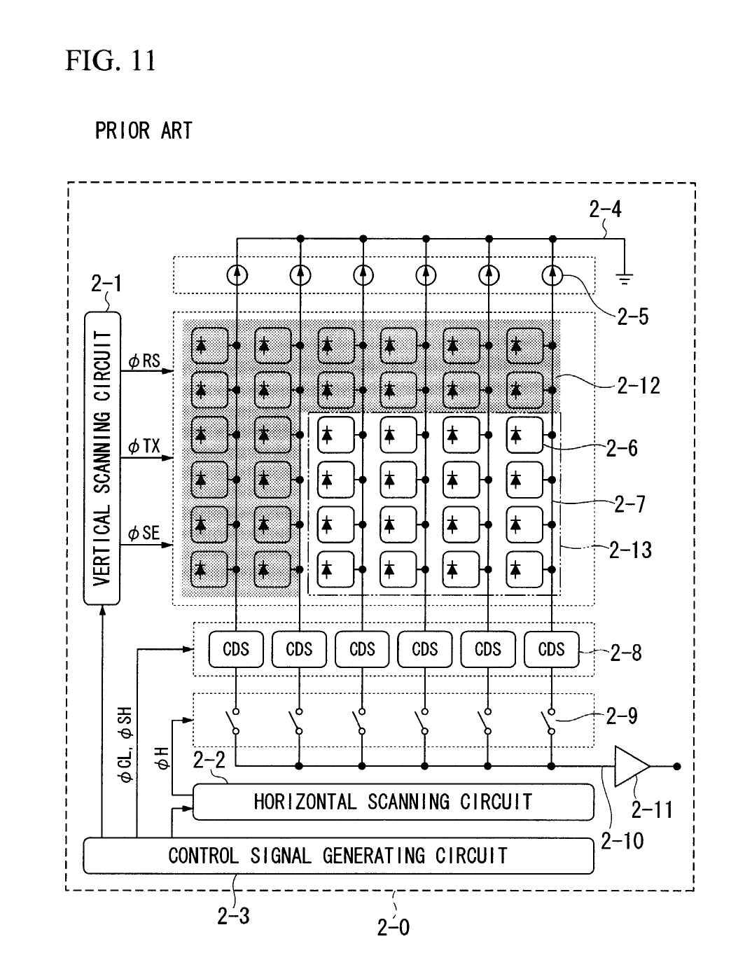

FIG. 1 shows the configuration of an MOS type image sensor 5-0 (solid state imaging device) according to the first embodiment. The MOS type image sensor 5-0 shown in FIG. 1 is assumed to have a pixel structure of six rows by six columns for the sake of simplicity. The same components as in the MOS type image sensor 2-0 shown in FIG. 11 are denoted by the same reference numerals as in FIG. 11.

Hereinafter, the components of the MOS type image sensor 5-0 shown in FIG. 1 will be described including the same components as in the MOS type image sensor 2-0 shown in FIG. 11. The following explanation is almost the same as the above explanation on the components of the MOS type image sensor 2-0 except that an explanation on a clipping circuit 5-1 and a control signal generating circuit 5-3 is different.

The MOS type image sensor 5-0 includes a vertical scanning circuit 2-1, a horizontal scanning circuit 2-2, a ground line 2-4, a current source 2-5, a pixel 2-6, a vertical signal line 2-7, a CDS circuit 2-8, a column selection switch 2-9, a horizontal signal line 2-10, an output amplifier 2-11, the clipping circuit 5-1, and the control signal generating circuit 5-3.

The pixel 2-6 includes a photodiode as a photoelectric conversion portion which converts the incident light into a signal charge and accumulates the converted signal charge. The vertical scanning circuit 2-1 controls the pixel 2-6. The vertical signal line 2-7 outputs a signal (pixel signal) of the pixel 2-6. The constant current source 2-5 drives the vertical signal line 2-7. The ground line 2-4 is connected to the constant current source 2-5. The CDS circuit 2-8 removes a noise component of a pixel signal.

The column selection switch 2-9 selects the vertical signal line 2-7. The horizontal signal line 2-10 outputs a signal of the vertical signal line 2-7. The output amplifier 2-11 amplifies a signal of the horizontal signal line 2-10. In addition, it is assumed that an OB region 2-12 shaded so that the light is not incident on the photoelectric conversion portion is formed by first and second row pixels and first and second column pixels out of the pixels 2-6 and an effective region 2-13 which is not shaded is formed by the other pixels.

The vertical scanning circuit 2-1 transmits to the pixel 2-6 a pixel reset pulse φRS, a charge transfer pulse φTX, and a pixel selection pulse φSE for controlling the pixel 2-6. The horizontal scanning circuit 2-2 transmits to the column selection switch 2-9 a column selection pulse φH for controlling the column selection switch 2-9. The control signal generating circuit 5-3 transmits to each of the vertical scanning circuit 2-1, the horizontal scanning circuit 2-2, and the CDS circuit 2-8 a command regarding its control. In addition, the control signal generating circuit 5-3 transmits to the CDS circuit 2-8 a clamp pulse φCL and a sample hold pulse φSH for controlling the CDS circuit 2-8. In addition, the control signal generating circuit 5-3 transmits a signal for controlling the clipping circuit 5-1 to the clipping circuit 5-1.

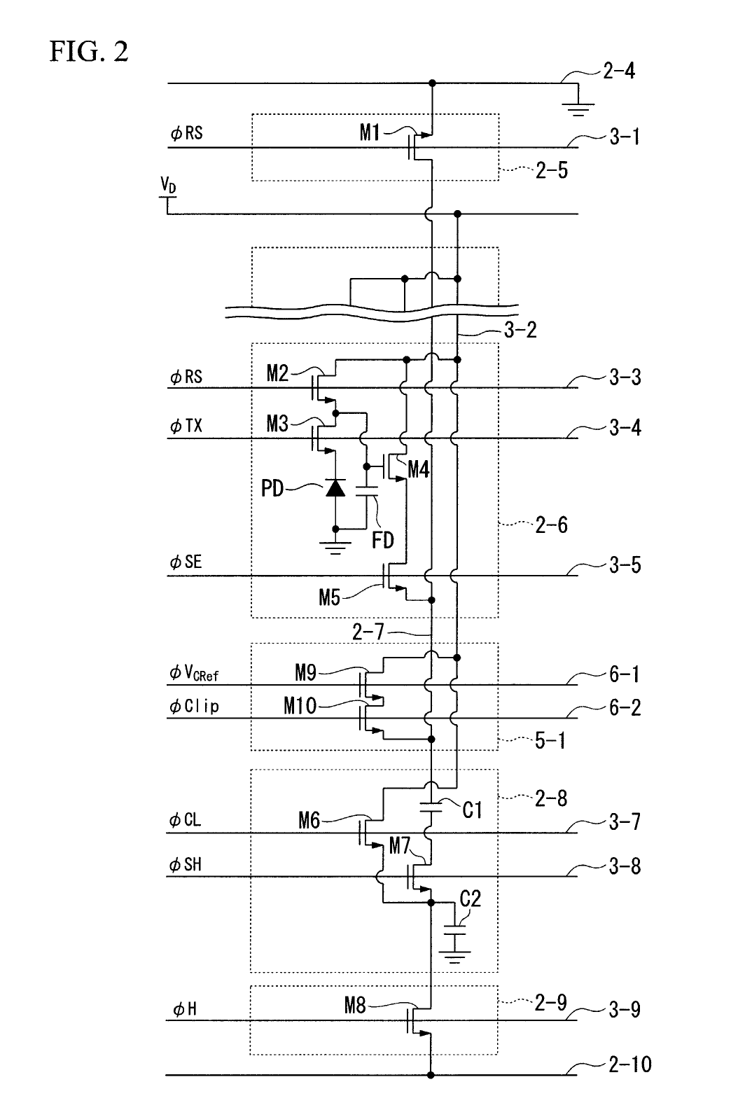

FIG. 2 shows the circuit configuration when a circuit corresponding to the pixels on a certain column in FIG. 1 is noted. The same components as in FIG. 1 are denoted by the same reference numerals as in FIG. 1. The constant current source 2-5 has a constant current source transistor M1 with a gate connected to a constant current source gate line 3-1. The pixel 2-6 converts the irradiated light into an electric signal and outputs it to the vertical signal line 2-7. The pixel 2-6 has a pixel reset transistor M2, a charge transfer transistor M3, an amplification transistor M4, a pixel selection transistor M5, a photodiode PD, and a floating diffusion FD. A gate of each transistor in the pixel 2-6 is connected to a pixel reset pulse line 3-3, a charge transfer pulse line 3-4, the floating diffusion FD, and a pixel selection pulse line 3-5. In addition, a common pixel power line 3-2 connected to all pixels is connected to drains of the pixel reset transistor M2 and amplification transistor M4.

The CDS circuit 2-8 serves to remove a different noise component for every pixel. The CDS circuit 2-8 has a clamp capacitor C1, a clamp transistor M6, a sample hold capacitor C2, and a sample hold transistor M7. A gate of each transistor in the CDS circuit 2-8 is connected to a clamp pulse line 3-7 and a sample hold pulse line 3-8. The column selection switch 2-9 has a column selection transistor M8 with a gate connected to a column selection pulse line 3-9.

The clipping circuit 5-1 has a clipping voltage generating transistor M9 and a clipping voltage control transistor M10. A gate of each transistor in the clipping circuit 5-1 is connected to a clipping voltage generating pulse line 6-1 and a clipping voltage control pulse line 6-2, and a drain of the clipping voltage generating transistor M9 is connected to the pixel power line 3-2. The clipping circuit 5-1 is controlled by a clipping voltage generating pulse φV_{CRef} and a clip voltage control pulse φClip from the control signal generating circuit 5-3. When the clipping voltage generating pulse φV_{CRef} is V_{C} and the clip voltage control pulse φClip is at a High level, the clipping circuit 5-1 clips the voltage of the vertical signal line 2-7 to a predetermined voltage.

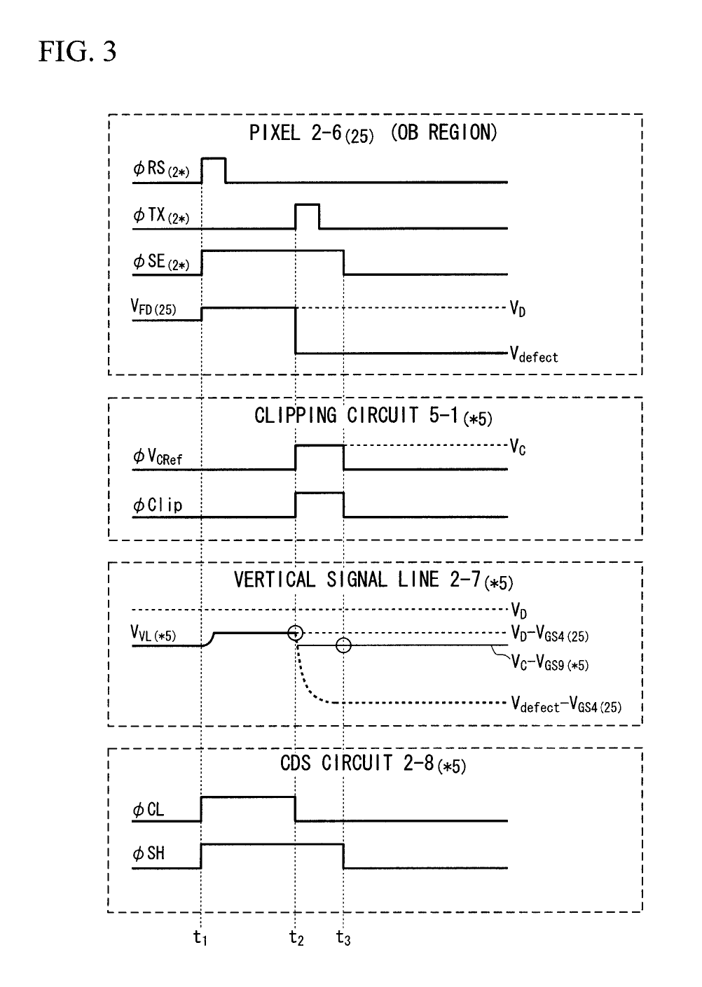

FIG. 3 shows an operation of the MOS type image sensor 5-0. Here, for the components shown in FIGS. 1 and 2, for example, a pixel on the second row and fifth column is expressed as a pixel 2-6₍₂₅₎. In addition, for the configuration common to the pixels on the same row or the same column, the number of the common row or column is expressed by *. For example, a constant current source corresponding to each pixel on the fifth column is expressed like the constant current source 2-5_{(*5)}. Hereinafter, an operation when the pixel 2-6₍₂₅₎ of the OB region 2-12 is a white defect due to manufacturing failure or the like will be described as an example. In FIG. 3, V_{FD} indicates a voltage of the floating diffusion FD, and V_{VL} indicates a voltage of the vertical signal line 2-7.

At time t₁, the pixel reset pulse φRS_{(2*)} changes to a High level. Then, a voltage V_{D} is applied to the pixel power line 3-2 and V_{FD(25)} is reset to V_{D}. In addition, assuming that the gate-to-source voltage of the amplification transistor M4 is V_{GS4}, V_{VL(*5)} is reset to the level of V_{D}-V_{GS4(25)}. Subsequently, at time t₂, the charge transfer pulse φTX_{(2*)} changes to a High level and all signals corresponding to the electric charges accumulated in the photodiode PD₍₂₅₎ are transmitted to the floating diffusion FD₍₂₅₎. Then, since V_{FD(25)} drops to V_{defect}, V_{VL(*5)} drops to V_{defect}-V_{GS4(25)}. In this case, V_{defect} is a voltage (voltage at the time of white defect) lower than the pixel of the surrounding OB region 2-12 due to manufacturing failure or the like and becomes a large level as a pixel output (white defect).

At the same time, however, the output potential of the clipping voltage generating pulse φV_{CRef} becomes V_{C} (V_{C}<V_{D)} at time t₂. Accordingly, the voltage of the source of the clipping voltage generating transistor M9 becomes V_{C}-V_{GS9(*5)}. Here, V_{GS9(*5)} is a gate-to-source voltage of the clipping voltage generating transistor M9. In addition, since the clipping voltage control pulse φClip changes to a High level, V_{VL(*5)} is clipped to V_{C}-V_{GS9(*5)}. Although the voltage V_{defect}-V_{GS4(25)} from the pixel 2-6₍₂₅₎ is also output to the vertical signal line 2-7_{(*5)}, V_{VL(*5)} is clipped to V_{C}-V_{GS9(*5)} higher than V_{defect}-V_{GS4(25)} by the operation of the clamp capacitor C1. By the above-described operation, the clipping circuit 5-1 clips V_{VL(*5)} such that V_{VL(*5)} does not become equal to or less than V_{C}-V_{GS9(*5)}.

At time t₃, the sample hold pulse φSH changes to a Low level. Then, V_{D}-V_{GS4(25)}-(V_{C}-V_{GS9(*5)}) is output to the horizontal signal line 2-10 as an image signal. In this case, V_{C} is a level when it is dark and is a level set beforehand as a level which is not abnormal. As an example, it is preferable that the V_{C} level be determined for every sensor when checking the sensor and the control signal generating circuit 5-3 store the V_{C} level. From the above operation, since the output of the white defect pixel is clipped to the voltage V_{C}-V_{GS9(*5)} corresponding to V_{C}, the pixel output from the OB region 2-12 can always be output as a level which is not abnormal.

As described above, according to the first embodiment, a means for storing or detecting the abnormal value of the pixel output from the shaded OB region becomes unnecessary. As a result, correction of the abnormal value can be performed with the simpler configuration. In addition, since the clipping circuit 5-1 is disposed between the pixel 2-6 and the CDS circuit 2-8, the correction of the abnormal value can be performed in the earlier phase than the phase in which a noise is removed from the pixel output. Accordingly, the correction of the abnormal value can be performed in the early phase of the signal processing. As a result, also when performing the signal processing (for example, average processing of signal charges on the column) in the previous stage of the AD conversion circuit or the previous stage of the CDS circuit, the signal processing can be performed under the conditions where the abnormal value from the OB region is corrected.

### Second Embodiment

Next, a second embodiment of the invention will be described. The second embodiment is related to a solid state imaging device to which a method of clipping a vertical signal line using a pixel (non-read pixel) other than a pixel (read pixel), to which a signal is read, is applied.

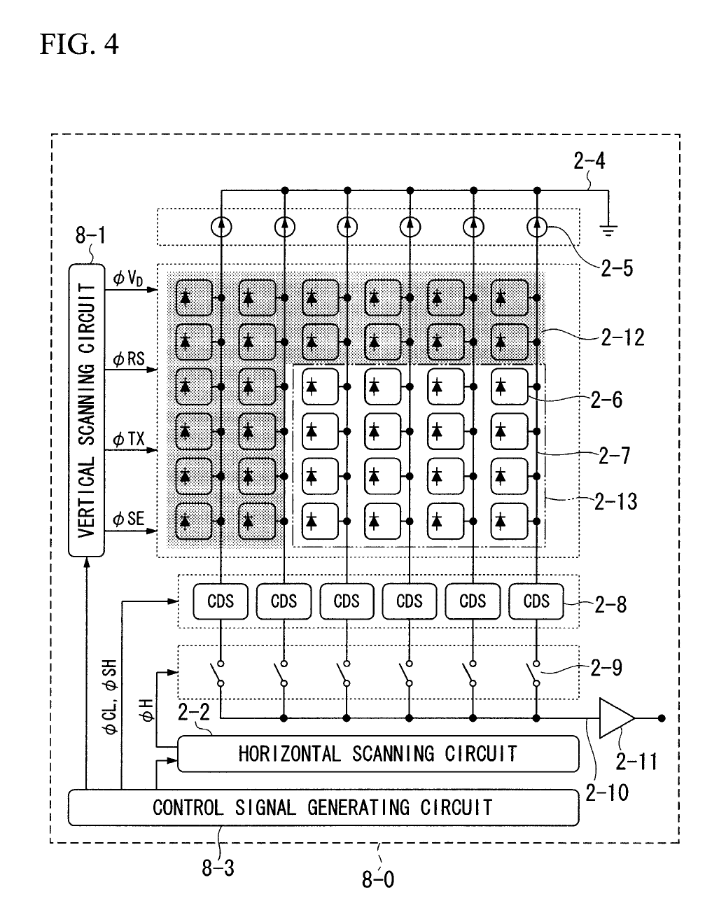

FIG. 4 shows the configuration of an MOS type image sensor 8-0 according to the second embodiment. The MOS type image sensor 8-0 shown in FIG. 4 is assumed to have a pixel structure of six rows by six columns for the sake of simplicity. The same components as in the MOS type image sensor 5-0 shown in FIG. 1 are denoted by the same reference numerals as in FIG. 1. A different point of the MOS type image sensor 8-0 from the MOS type image sensor 5-0 is a vertical scanning circuit 8-1 and a control signal generating circuit 8-3. The vertical scanning circuit 8-1 transmits to the pixel 2-6 a pixel reset pulse φRS, a charge transfer pulse φTX, a pixel selection pulse φSE, and a power supply voltage pulse φV_{D} for controlling the pixel 2-6. The power supply voltage pulse φV_{D} can be output as an independent value which is different for every row. The control signal generating circuit 8-3 transmits to each of the vertical scanning circuit 8-1, the horizontal scanning circuit 2-2, and the CDS circuit 2-8 a command regarding its control.

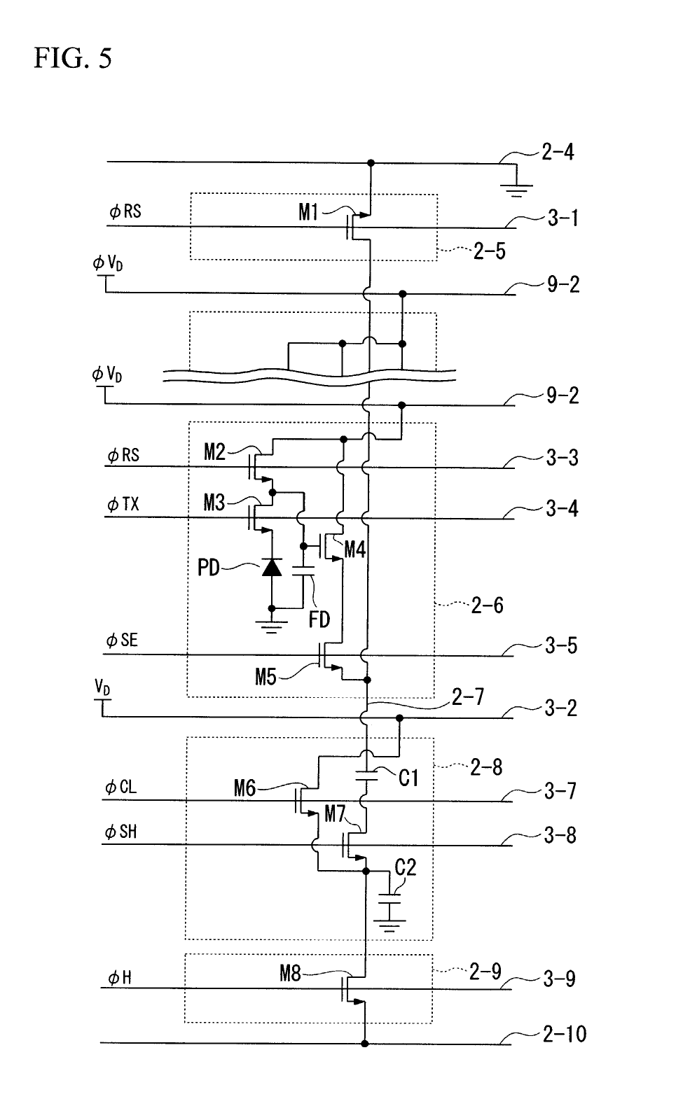

FIG. 5 shows the circuit configuration when a circuit corresponding to the pixels on a certain column in FIG. 4 is noted. The same components as in FIG. 2 are denoted by the same reference numerals as in FIG. 2. In FIG. 5, a different point from FIG. 2 is a pixel power pulse line 9-2. While the pixel power line 3-2 in FIG. 2 is a common signal line connected to all pixels, the pixel power pulse line 9-2 in FIG. 5 is a signal line which is independent for every line and the power supply voltage pulse φV_{D} which is different for every row can be applied by the vertical scanning circuit 8-1.

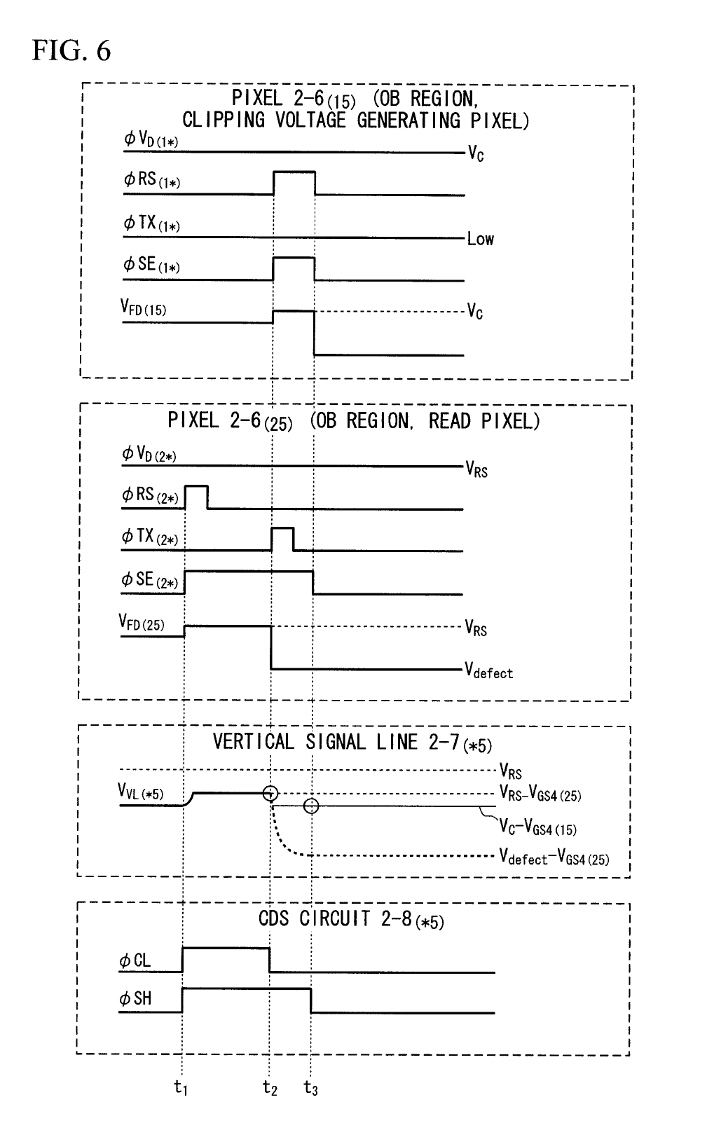

FIG. 6 shows an operation of the MOS type image sensor 8-0. The same components as in FIG. 3 are denoted by the same reference numerals as in FIG. 3. FIG. 6 is different from FIG. 3 in that the power supply voltage pulse φV_{D} which is different for every row is used and the clipping voltage V_{C} is generated by using a non-read pixel other than a read pixel. A read pixel and a non-read pixel are set by the vertical scanning circuit 8-1. Hereinafter, a pixel which generates the clipping voltage is assumed to be a clipping voltage generating pixel. In addition, an explanation will be made assuming that the pixel 2-6₍₁₅₎ is a clipping voltage generating pixel and the pixel 2-6₍₂₅₎ is a read pixel.

At time t₁, the pixel reset pulse φRS_{(2*)} changes to a High level. Then, a voltage V_{RS} is applied to the pixel power line 3-2 and the voltage V_{FD(25)} of the floating diffusion FD of the read pixel 2-6₍₂₅₎ is reset to V_{RS}. In addition, assuming that the gate-to-source voltage of the amplification transistor M4 is V_{GS4}, the voltage V_{VL(*5)} of the vertical signal line 2-7_{(*5)} is reset to the level of V_{RS}-V_{GS4(25)}. Subsequently, at time t₂, the charge transfer pulse φTX_{(2*)} changes to a High level and all signals corresponding to the electric charges accumulated in the photodiode PD₍₂₅₎ are transmitted to the floating diffusion FD₍₂₅₎. Then, since V_{FD(25)} drops to V_{defect}, V_{VL(*5)} drops to V_{defect}. In this case, V_{defect} is a voltage (voltage at the time of white defect) lower than the pixel of the surrounding OB region 2-12 due to manufacturing failure or the like and becomes a large level as a pixel output (white defect).

At the same time, however, the power supply voltage pulse φV_{D(1*)} becomes V_{C}, the pixel reset pulse φRS_{(1*)} changes to a High level, and the charge transfer pulse φTX_{(1*)} changes to a Low level at time t₂. Accordingly, the voltage V_{FD(15)} of the floating diffusion FD of the clipping voltage generating pixel 2-6₍₁₅₎ becomes V_{C}. At this time, V_{VL(*5)} is clipped to V_{C}-V_{GS4(15)}, which is higher than V_{defect}-V_{GS4(25)}, by the same operation as in the first embodiment.

At time t3, the sample hold pulse φSH changes to a Low level. Then, V_{RS}-V_{GS4(25)}-(V_{C}-V_{GS4(15)}) is output to the horizontal signal line 2-10 as an image signal. The setting method of the clipping voltage V_{C} is the same as that in the first embodiment. From the above operation, since the output of the white defect pixel is clipped to the voltage V_{C}-V_{GS4(15)} corresponding to V_{C}, the pixel output from the OB region 2-12 can always be output as a level which is not abnormal.

As described above, according to the second embodiment, correction of the abnormal value can be performed with the simpler configuration and in the early phase of the signal processing, similar to the first embodiment. In addition, in the second embodiment, the voltage of the vertical signal line 2-7 is clipped by the output of a non-read pixel. Accordingly, since it is not necessary to separately provide a clipping circuit unlike the first embodiment, the chip area can be made smaller than that in the first embodiment.

Moreover, the clipping voltage generating pixel has the same configuration as the configuration of the normal pixel, which includes the pixel reset transistor M2 or the pixel selection transistor M5 in addition to the photodiode FD. Accordingly, the chip area can be made smaller than that in the first embodiment without changing the configuration of the pixel.

Any pixel may be used as the clipping voltage generating pixel as long as it is a non-read pixel on the same column.

In the manufacturing process, it may be considered that the voltages V_{GS} of transistors located close to each other in a wafer are close values (for example, V_{GS4(25)}≅V_{GS4(15)}). Accordingly, a variation in the output when clipping the vertical signal line 2-7, which is caused by the variation in the voltage V_{GS}, can be reduced by using a pixel near a read pixel as a clipping voltage generating pixel.

### Third Embodiment

Next, a third embodiment of the invention will be described. The third embodiment is related to a solid state imaging device to which a method of preparing the OB region optimized only for clipping and of clipping a vertical signal line using the pixel is applied.

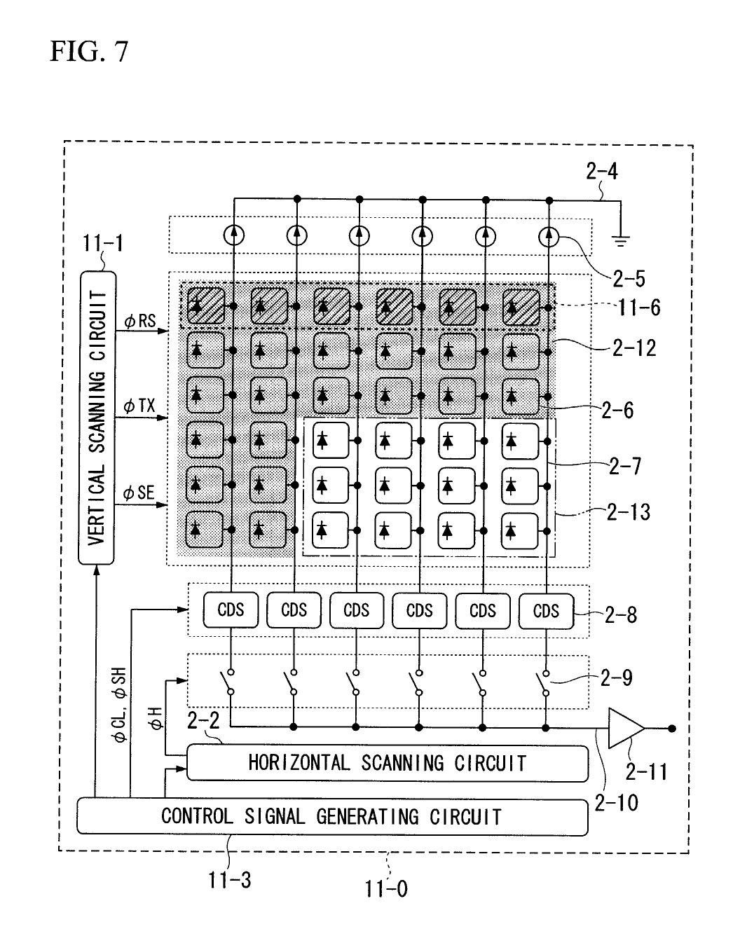

FIG. 7 shows the configuration of an MOS type image sensor 11-0 according to the third embodiment. The MOS type image sensor 11-0 shown in FIG. 7 is assumed to have a pixel structure of six rows by six columns for the sake of simplicity. The same components as in the MOS type image sensor 2-0 shown in FIG. 11 are denoted by the same reference numerals as in FIG. 11. Here, the OB region 2-12 is formed by one to third row pixels and first and second column pixels out of the pixels 2-6 for explanations. A different point of the MOS type image sensor 11-0 from the MOS type image sensor 2-0 is a vertical scanning circuit 11-1, a control signal generating circuit 11-3, and the pixel structure on the first row. The vertical scanning circuit 11-1 transmits to the pixel 2-6 a pixel reset pulse φRS, a charge transfer pulse φTX, and a pixel selection pulse φSE for controlling the pixel 2-6. In this case, for the pixel 2-6_{(1*)} on the first row, the vertical scanning circuit 11-1 generates a pulse at a different predetermined timing from the other pixels. The control signal generating circuit 11-3 transmits to each of the vertical scanning circuit 11-1, the horizontal scanning circuit 2-2, and the CDS circuit 2-8 a command regarding its control.

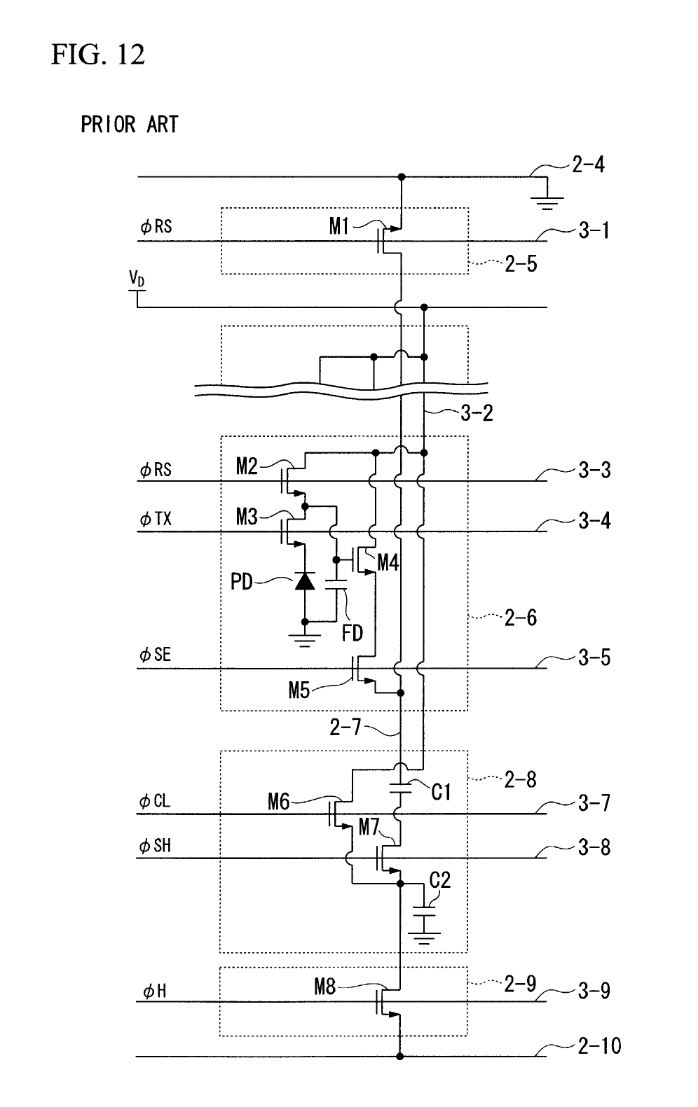

The circuit configuration (not shown) when a certain column is noted is the same as the configuration of FIG. 12. In the third embodiment, however, the capacitance value of the floating diffusion FD of a pixel on the first row out of the pixels 2-6 is set to be smaller than that of the floating diffusion FD of pixels on the second and third rows. For this reason, even if the photodiode PD generates the same dark current under the same storage time and temperature, the output voltage from the pixel on the first row necessarily becomes a value lower than those from the pixels on the second and third rows.

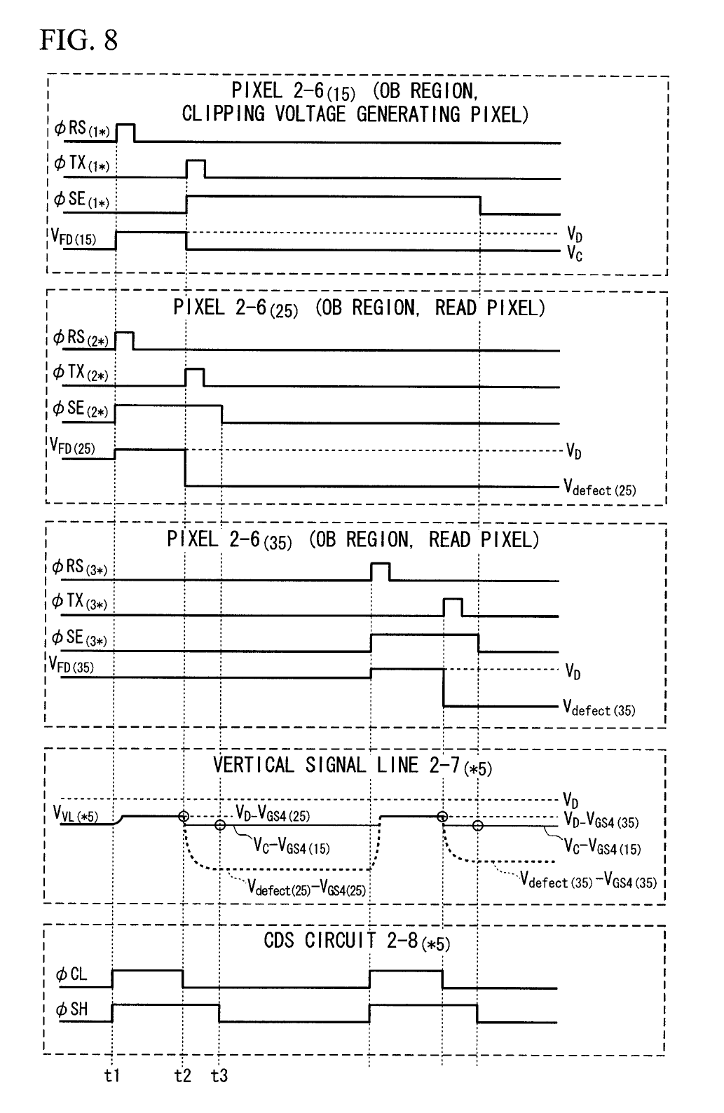

FIG. 8 shows an operation of the MOS type image sensor 11-0. The same components as in FIG. 6 are denoted by the same reference numerals as in FIG. 6. FIG. 8 is different from FIG. 6 in that the clipping voltage V_{C} is generated under the conditions in which a clipping voltage generating pixel 11-6 on the first row, which is provided to generate a clipping voltage, is always ON. Hereinafter, an explanation will be made assuming that the pixel 2-6₍₁₅₎ is a clipping voltage generating pixel and the pixel 2-6₍₂₅₎ is a read pixel.

At time t₁, the pixel reset pulse φRS_{(2*)} changes to a High level. Then, a voltage V_{D} is applied to the pixel power line 3-2 and V_{FD(25)} is reset to V_{D}. In addition, assuming that the gate-to-source voltage of the amplification transistor M4 is V_{GS4}, the voltage V_{VL(*5)} of the vertical signal line 2-7 is reset to the level of V_{D}-V_{GS4(25)}. Subsequently, at time t₂, the charge transfer pulse φTX_{(2*)} changes to a High level and all signals corresponding to the electric charges accumulated in the photodiode PD₍₂₅₎ are transmitted to the floating diffusion FD₍₂₅₎. Then, since V_{FD(25)} drops to V_{defect}, V_{VL(*5)} drops to V_{defect}-V_{GS4(25)}. In this case, V_{defect} is a voltage (voltage at the time of white defect) lower than the pixel of the surrounding OB region 2-12 due to manufacturing failure or the like and becomes a large level as a pixel output (white defect).

On the other hand, in the clipping voltage generating pixel 11-6 on the first row, the pixel reset pulse φRS_{(1*)} changes to a High level at time t₁, and the charge transfer pulse φTX_{(1*)} changes to a High level at time t₂. As described above, in the third embodiment, the capacitance value of the floating diffusion FD of a pixel on the first row is set to be smaller than that of the floating diffusion FD of pixels on the second and third rows. For this reason, even if the photodiode PD generates the same dark current under the same storage time and temperature, the output voltage from the pixel on the first row becomes a value (low value as a pixel output) higher than those from the pixels on the second and third rows. Accordingly, V_{FD(15)} becomes V_{C} higher than V_{FD} of the pixels on the second and third rows, and V_{VL(*5)} is clipped to V_{C}-V_{GS4(15)} by the same operation as in the first embodiment. At time t₃, the sample hold pulse φSH changes to a Low level. Then, V_{D}-V_{GS4(25)}-(V_{C}-V_{GS4(15)}) is output to the horizontal signal line 2-10 as an image signal. The setting method of the clipping voltage V_{C} is the same as that in the first embodiment.

As shown in FIG. 8, the pixel 2-6₍₃₅₎ on the third row of the OB region 2-12 performs the same operation. At this time, the clipping voltage generating pixel 11-6 on the first row is always ON, and the vertical signal line 2-7 is clipped in the same manner as described above. The clipping voltage generating pixel 11-6 on the first row accumulates the electric charges in the floating diffusion FD while the other pixels of the OB region 2-12 are being read. Accordingly, the voltage gradually drops due to the influence of a dark current. However, in the actual solid state imaging device, the pixels of the OB region are small compared with the pixels of the effective region and the read time of the pixels of the OB region is short. Accordingly, the influence of the dark current can almost be neglected. In the third embodiment, as an example, the clipping voltage generating pixel is generated using only the capacitance value of the floating diffusion FD as a parameter. However, the invention is not limited thereto. From the above operation, since the output of the white defect pixel is clipped to the voltage V_{C}-V_{GS4(15)} corresponding to V_{C}, the pixel output from the OB region 2-12 can always be output as a level which is not abnormal. In addition, in the third embodiment, the clipping voltage optimized by the temperature or storage time can be automatically generated.

As described above, according to the third embodiment, correction of the abnormal value can be performed with the simpler configuration and in the early phase of the signal processing, similar to the first embodiment. In addition, in the third embodiment, the voltage of the vertical signal line 2-7 is clipped by the output of the clipping voltage generating pixel 11-6. Accordingly, since it is not necessary to separately provide a clipping circuit unlike the first embodiment, the chip area can be made smaller than that in the first embodiment.

Moreover, the clipping voltage generating pixel 11-6 has the same configuration as the configuration of the normal pixel, which includes the pixel reset transistor M2 or the pixel selection transistor M5 in addition to the photodiode FD. Accordingly, the chip area can be made smaller than that in the first embodiment without changing the configuration of the pixel.

### Fourth Embodiment

Next, a fourth embodiment of the invention will be described. The fourth embodiment is related to a solid state imaging device to which a method of providing a temperature measuring circuit and of changing the clipping voltage by the output of the temperature measuring circuit is applied.

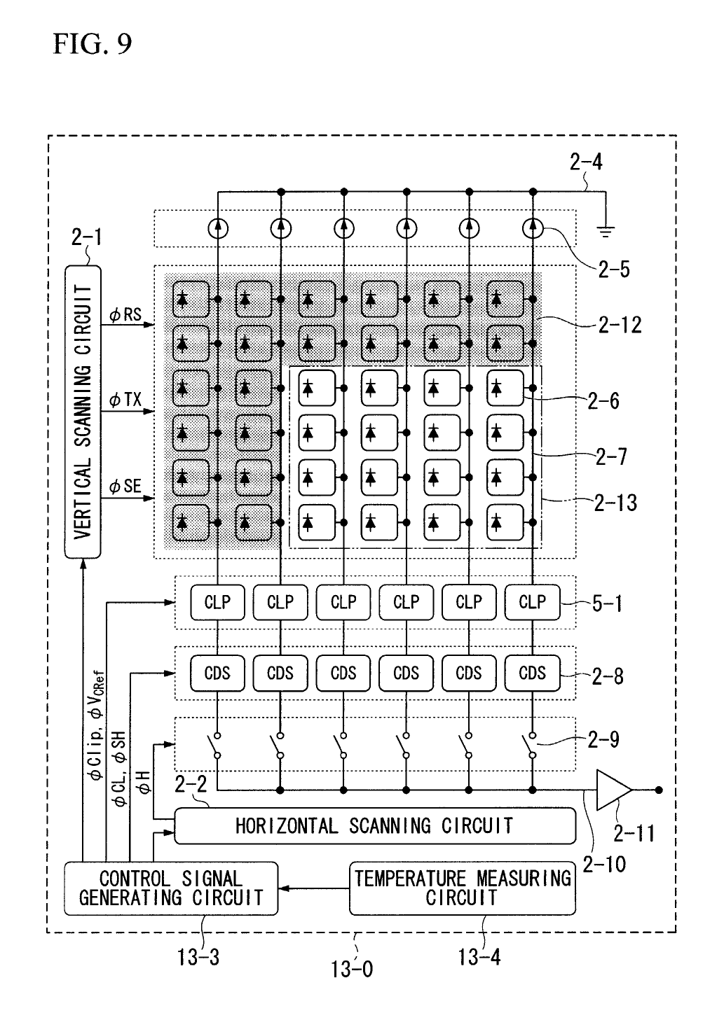

FIG. 9 shows the configuration of an MOS type image sensor 13-0 according to the fourth embodiment. The MOS type image sensor 13-0 shown in FIG. 9 is assumed to have a pixel structure of six rows by six columns for the sake of simplicity. The same components as in the MOS type image sensor 5-0 shown in FIG. 1 are denoted by the same reference numerals as in FIG. 1. The MOS type image sensor 13-0 is different from the MOS type image sensor 5-0 in that a control signal generating circuit 13-3 and a temperature measuring circuit 13-4 are added.

The control signal generating circuit 13-3 transmits a command regarding its control to each of the vertical scanning circuit 2-1, the horizontal scanning circuit 2-2, and the CDS circuit 2-8. In addition, the control signal generating circuit 13-3 receives an output of the temperature measuring circuit 13-4 and transmits the appropriate clipping level φV_{CRef} to the clipping circuit 5-1 according to each temperature. Generally, the black level is influenced by the temperature. Therefore, in order to clip the vertical signal line clip with a correct value, it is desirable to change the clipping level generated in the clipping circuit 5-1 according to the temperature.

In the fourth embodiment, the black level clipped appropriately can be output all the time by providing the temperature measuring circuit 13-4 in the MOS type image sensor 13-0 and changing the clipping level φV_{CRef} according to the output of the temperature measuring circuit 13-4. In addition, the black level is also influenced by the shutter time which decides the time for which signal charges are accumulated. The control signal generating circuit 13-3 also transmits the appropriate clipping level φV_{CRef} to the clipping circuit 5-1 according to the shutter time.

In general, as the temperature rises, generation of thermal electrons increases. Then, the pixel output of the OB region 2-12 increases, and the output voltage from the pixel of the OB region 2-12 drops. As described above, the clipping circuit 5-1 clips the voltage V_{VL} so that the voltage V_{VL} of the vertical signal line 2-7 becomes equal to or less than a predetermined voltage. Accordingly, when the output voltage from the pixel of the OB region 2-12 drops, the voltage V_{VL} will erroneously be clipped even if the read pixel is not a white defect pixel. For this reason, the control signal generating circuit 13-3 operates to lower the clipping level φV_{CRef} when the temperature has risen and to raise the clipping level φV_{CRef} when the temperature has dropped.

In addition, also when the shutter time has increased, the pixel output of the OB region 2-12 increases and the output voltage from the pixel of the OB region 2-12 drops. Therefore, similar to those described above, the control signal generating circuit 13-3 operates to lower the clipping level φV_{CRef} when the shutter time has increased and to raise the clipping level φV_{CRef} when the shutter time has decreased.

According to the fourth embodiment, correction of the abnormal value can be performed with the simpler configuration and in the early phase of the signal processing, similar to the first embodiment. In addition, in the fourth embodiment, also when the output voltage from the pixel of the OB region 2-12 has been changed according to the temperature or shutter time, the black level clipped appropriately can be output all the time.

That is, according to the invention, a means for storing or detecting the abnormal value of the output from the shaded pixel becomes unnecessary. As a result, correction of the abnormal value can be performed with the simpler configuration. In addition, according to the invention, the correction of the abnormal value is performed by fixing the level of a signal line connected to the second pixel. Accordingly, the correction of the abnormal value can be performed, for example, in the earlier phase than the phase in which a noise is removed from a pixel signal output to the signal line. As a result, the correction of the abnormal value can be performed in the early phase of the signal processing.

While the embodiments of the invention have been described in detail with reference to the accompanying drawings, the specific configuration of the invention is not limited to the above-described embodiments, and a design change and the like within the scope without departing from the subject matter of the invention are also included. For example, although the above explanation has been made using the pixel structure of six rows by six columns, the number of rows and the number of columns may be changed when necessary. For the other components, the invention is not limited only to the above-described embodiments.

Moreover, in the above explanation, when the pixel of the OB region is a read pixel, the voltage V_{VL} of the vertical signal line is clipped so that the voltage V_{VL} of the vertical signal line corresponding to the read pixel does not become equal to or less than a predetermined voltage. However, when the waveform of the voltage V_{VL} of the vertical signal line is the inverse wavelength of the wavelength shown in FIG. 3 or the like, it is preferable that the voltage V_{VL} of the vertical signal line be clipped so that the voltage V_{VL} of the vertical signal line corresponding to the read pixel does not become equal to or more than a predetermined voltage.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A solid state imaging device comprising:
a plurality of first pixels including a photoelectric conversion portion which converts incident light into a signal charge and accumulates the signal charge;
a plurality of second pixels which includes the photoelectric conversion portion and is shaded so that the incident light is not incident on the photoelectric conversion portion;
a signal line which is electrically connected to the first or second pixel and transmits a pixel signal, which corresponds to the signal charge and is output from the first or second pixel; and
a fixing portion which fixes a level of the signal line so that the level of the signal line connected to the second pixel does not become equal to or more than a predetermined level or does not become equal to or less than the predetermined level.

2. The solid state imaging device according to claim 1, further comprising a noise removing portion which removes a noise from the pixel signal output to the signal line, wherein the fixing portion is disposed between a point, at which the first or second pixel is connected to the signal line, and the noise removing portion.

3. The solid state imaging device according to claim 1, wherein the fixing portion is provided with the first or second pixel.

4. The solid state imaging device according to claim 3, wherein the first or second pixel which forms the fixing portion comprises:
a reset portion which resets the signal charge accumulated in the first or second pixel; and
a selection portion which selects an output of the first or second pixel.

5. The solid state imaging device according to claim 1, further comprising a setting portion which sets the pixel, to which a signal is to be output, out of the first and second pixels, wherein the fixing portion is provided with the second pixels other than the pixel to which a signal is to be output.

6. The solid state imaging device according to claim 1, further comprising a control portion which controls the level of a voltage as a reference used to determine the predetermined level according to temperature.

7. The solid state imaging device according to claim 1, further comprising a control portion which controls the level of a voltage as a reference used to determine the predetermined level according to the time for which the signal charge is accumulated.
